(19) United States
(12) Patent Application Publication
(10) Pub. No.: US 2016/0138362 A1
(43) Pub. Date: May 19, 2016

(54) 3-D PRINTED DOWNHOLE COMPONENTS

(71) Applicant: HALLIBURTON ENERGY SERVICES, INC., Houston, TX (US)

(72) Inventor: David Allen Dockweiler, Mckinney, TX (US)

(21) Appl. No.: 14/896,172

(22) PCT Filed: Feb. 5, 2014
(86) PCT No.: PCT/US2014/014867

§ 371 Date: Dec. 4, 2015

(51) Int. Cl. E21B 33/129

(52) U.S. Cl. CPC E21B 33/1291; E21B 33/129; B33Y 80/00

(57) ABSTRACT

A downhole tool for use in a well includes a mandrel, a sealing element disposed about the mandrel for engaging the well in a set position of the tool, a retaining shoe at one of the first and second ends of the sealing element, and a slip wedge disposed about the mandrel abutting the retaining shoe. The downhole tool includes components made by a 3-D printing process.

### FIELD OF THE INVENTION

Downhole tools for use in wellbores often have components made at least partially of composite or non-metallic materials, such as engineering grade plastics, composites, and resins. Downhole tools, such as for example packers, bridge plugs and frac plugs sometimes have components that are, because of the configuration of such components, difficult to fabricate. Disclosed herein are downhole tools with components fabricated using a three-dimensional printing process.

### BACKGROUND OF THE INVENTION

In the drilling or reworking of oil wells, a great variety of downhole tools are used. For example, but not by way of limitation, it is often desirable to seal tubing or other pipe in the casing of the well, such as when it is desired to pump cement or other slurry down the tubing and force the cement or slurry around the annulus of the tubing or out into a formation. It then becomes necessary to seal the tubing with respect to the well casing and to prevent the fluid pressure of the slurry from lifting the tubing out of the well or for otherwise isolating specific zones in a well. Downhole tools referred to as packers and bridge plugs are designed for these general purposes and are well known in the art of producing oil and gas.

When it is desired to remove many of these downhole tools from a wellbore, it is frequently simpler and less expensive to mill or drill them out rather than to implement a complex retrieving operation. In milling a milling cutter is used to grind the packer or plug, for example, or at least the outer components thereof, out of the downhole tool to remove it from the wellbore. This is a much faster operation than milling, but requires the tool to be made out of materials which can be accommodated by the drill bit. To facilitate removal of packer-type tools by milling or drilling, packers and bridge plugs have been made to the extent practical, of non-metallic materials such as engineering-grade plastics and composites.

Many of the components that make up packers, bridge plugs and frac plugs are of relatively complex geometry. The process of machining and/or fabricating the metallic and non-metallic components of such tools can be time-consuming and expensive. Thus, there is a continued need to develop fabricating techniques that will speed the process of fabricating components utilized in packers, bridge plugs and frac plugs and other downhole tools.

### BRIEF DESCRIPTION OF THE DRAWINGS

FIG. 1 is a cross-sectional side view of the packer apparatus having upper and lower retaining shoes embodying the present invention.

FIG. 2 is a cross-sectional side view of the packer element assembly and the retaining shoes of the present invention.

FIG. 3 is a cross-sectional side view of the packer apparatus of the present invention in a set position.

FIG. 4 is a top view of an inner shoe of the retaining shoe of the present invention.

FIG. 5 is a perspective view of a single inner shoe segment.

FIG. 6 is a top view of the outer shoe of the retaining shoe of the present invention.

FIG. 7 is a perspective view of a single outer shoe segment of the present invention.

FIG. 8 is a perspective view of the retaining shoe of the present invention.

FIG. 9 is a cross-sectional side view of a prior art packer element and a retainer shoe.

FIG. 10 shows a cross-section of an alternative embodiment of a retaining shoe of the present invention.

### DESCRIPTION OF PREFERRED EMBODIMENTS

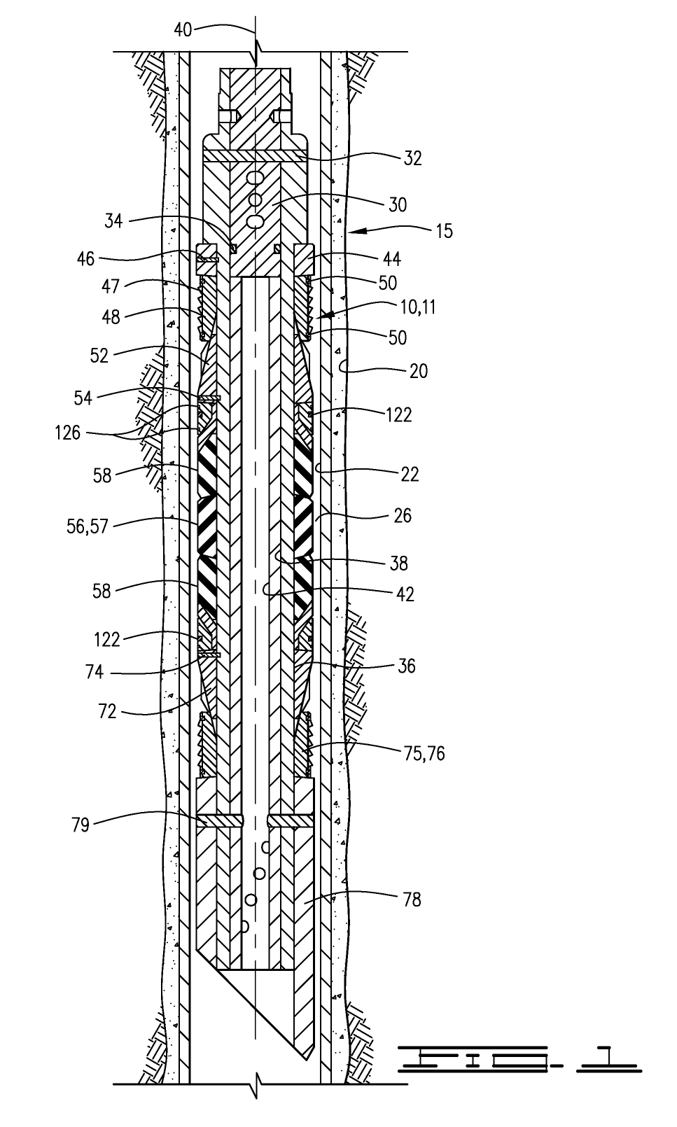

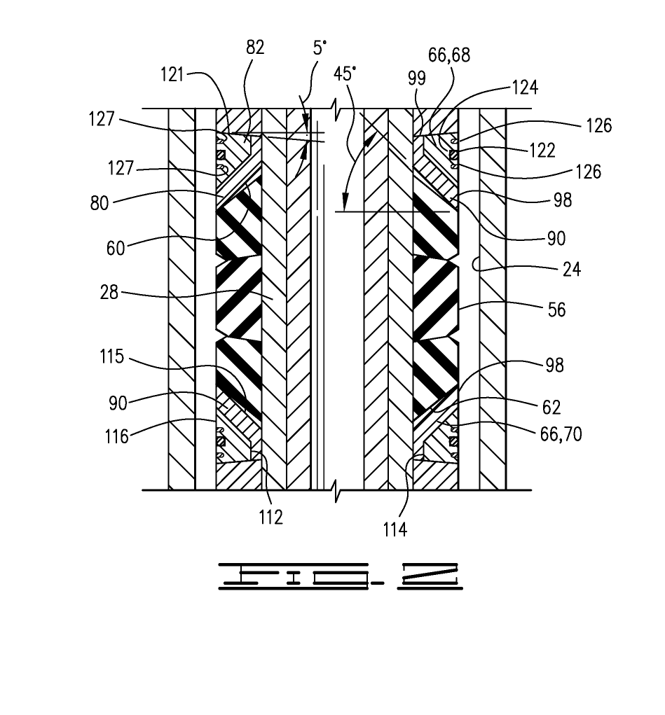

Referring now to FIGS. 1 and 2, downhole tool, or downhole apparatus 10 is shown in an unset position 11 in a well 15 having a wellbore 20 with a casing 22 cemented therein. Apparatus 10 is shown in set position 13 in FIG. 3. Casing 22 has an inner surface 24. An annulus 26 is defined by casing 22 and downhole tool 10. Downhole tool 10 has a mandrel 28, and may be referred to as a bridge plug due to the tool having a plug 30 being pinned within mandrel 28 by radially oriented pins 32. Plug 30 has a seal means 34 located between plug 30 and the internal diameter of mandrel 28 to prevent fluid flow therebetween. The overall tool structure, however, is adaptable to tools referred to as packers, which typically have at least one means for allowing fluid communication through the tool. Packers may therefore allow for the controlling of fluid passage through the tool by way of a one or more valve mechanisms which may be integral to the packer body or which may be externally attached to the packer body. Such valve mechanisms are not shown in the drawings of the present document. Packer tools may be deployed in wellbores having casings or other such annular structure or geometry in which the tool may be set.

Mandrel 28 has an outer surface 36 an inner surface 38, and a longitudinal central axis, or axial centerline 40. An inner tube 42 is disposed in, and is pinned to mandrel 28 to help support plug 30.

Tool 10, which may also be referred to as packer apparatus 10, includes the usage of a spacer ring 44 which is preferably secured to mandrel 28 by pins 46. Spacer ring 44, which may also be referred to as support ring 44, provides an abutment which serves to axially retain slip ring 47, which is comprised of slip segments 48 positioned circumferentially about mandrel 28. Slip segments 48 may have buttons 49 to engage the casing 22. Slip retaining bands 50 serve to radially retain slips 48 in an initial circumferential position about mandrel 28 as well as slip wedge 52. Bands 50 are made of a steel wire, a plastic material, or a composite material having the requisite characteristics of sufficient strength to hold the slips in place prior to actually setting the tool and to be easily drillable when the tool is to be removed from the wellbore. Preferably bands 50 are inexpensive and easily installed about slip segments 48. Slip wedge 52 is initially positioned in a slidable relationship to, and partially underneath slip segments 48 as shown in FIG. 1. Slip wedge 52 is shown pinned into place by pins 54.

Located below slip wedge 52 is a packer element assembly 56, which includes at least one packer element, and as shown in FIG. 1 includes three expandable elements 58 positioned about mandrel 28. Packer element assembly 56 has unset and set positions 57 and 59 corresponding to the unset and set positions 11 and 13 of tool 10. Assembly 56 has upper end 60 and lower end 62.

Referring to FIG. 1, the present invention has retaining rings 66 disposed at the upper and lower ends of packer element assembly 56. Retaining rings or retaining shoes 66 may be referred to as an upper retaining shoe or upper retainer 68 and a lower retaining shoe or lower retainer 70. A slip wedge 72 is disposed on mandrel 28 below lower retaining shoe 70 and is pinned with a pin 74. Located below lower slip wedge 72 is lower slip ring 75, which is comprised of lower slip segments 76. Lower slip wedge 72 and lower slip segments 76 are like upper slip wedge 52 and upper slip segments 48. At the lowermost portion of tool 10 is an angled portion referred to as mule shoe 78, secured to mandrel 28 by pin 79. Lowermost portion 78 need not be a mule shoe but can be any type of section which will serve to terminate the structure of the tool or serves to be a connector for connecting the tool with other tools, a valve or tubing, etc. It will be appreciated by those in the art that pins 32, 46, 54, 74 and 79 if used at all are preselected to have shear strengths that allow for the tool to be set and deployed and to withstand the forces expected to be encountered in a wellbore during the operation of the tool.

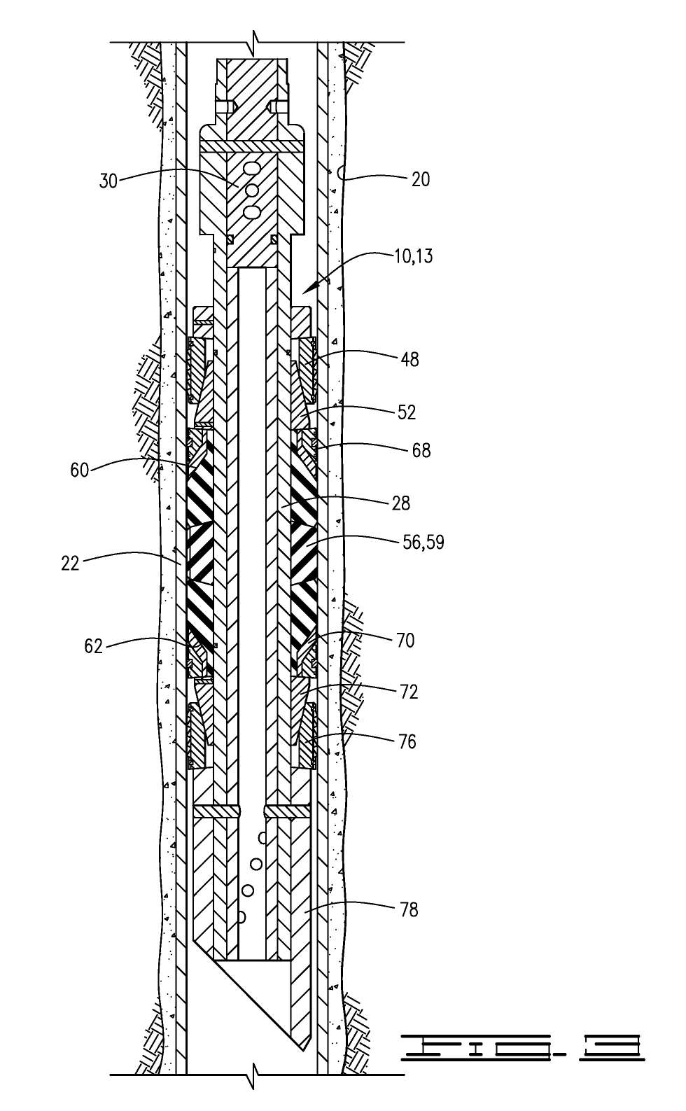

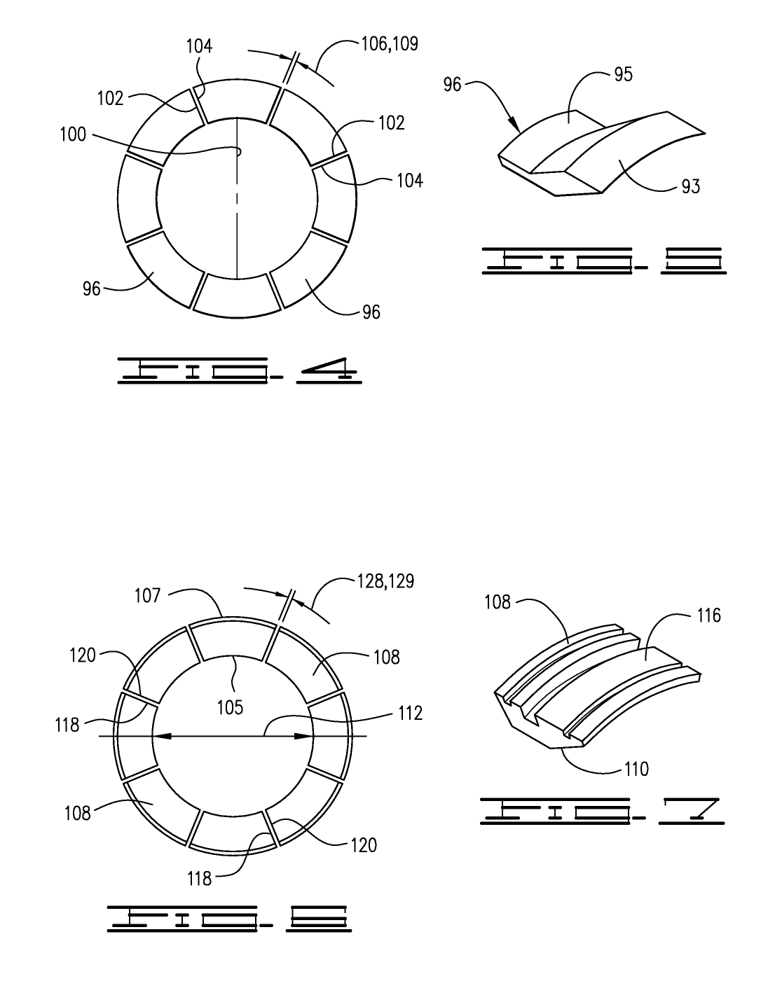

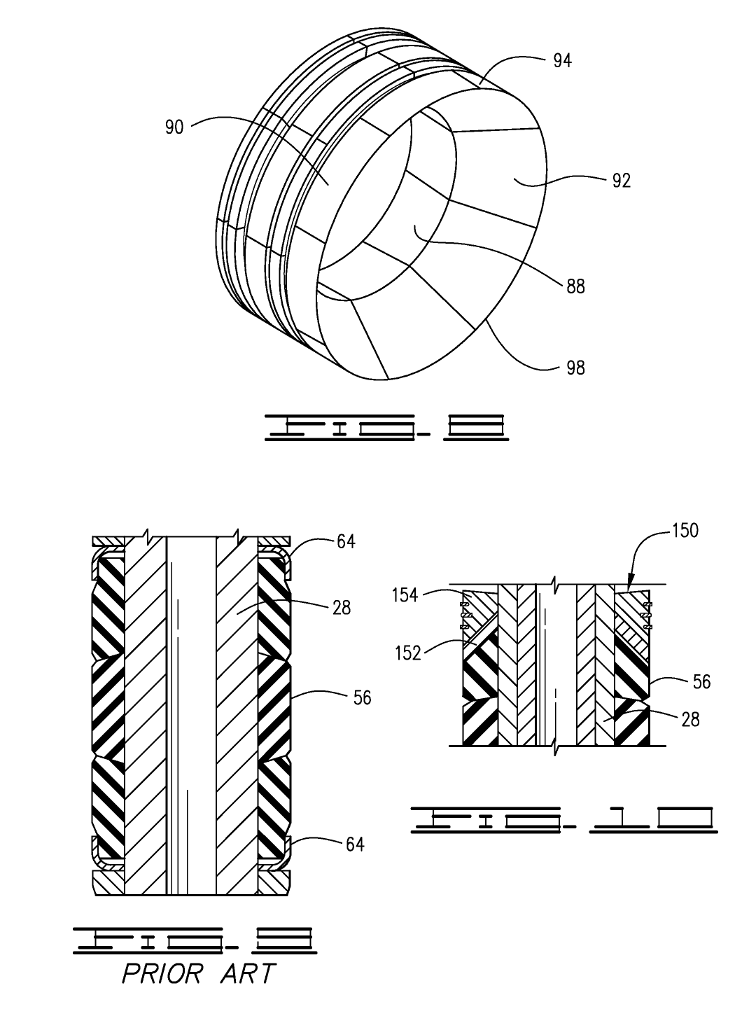

Referring now to FIGS. 2 and 4-8, the retaining shoes of the present invention will be described. Upper and lower retaining shoes 68 and 70 are essentially identical. Therefore, the same designating numerals will be used to further identify features on each of retaining shoes 68 and 70, which are referred to collectively herein as retaining shoes 66. Retaining shoes 66 comprise an inner shoe or inner retainer 80 and an outer shoe or outer retainer 82. Inner and outer shoes 80 and 82 may also be referred to as first and second shoes or retainers 80 and 82.

Referring now to FIGS. 2, 4, 5 and 8, inner shoe 80 has a body 88 and a fin or wing 90 extending radially outwardly therefrom. Inner shoe 80 has an inner surface 92 and an outer surface 94. As shown in FIG. 2, upper and lower ends 60 and 62 of packer element assembly 56 reside directly against upper and lower retainers 68 and 70 and preferably directly against wing 90 of inner shoe 80 at both the upper and lower ends 60 and 62 thereof. Inner shoe 80 is preferably comprised of a plurality of first or inner shoe segments 96 to form an inner shoe 80 that encircles mandrel 28. Inner surface 92 of inner shoe 80 is shaped to accommodate the ends 60 and 62 of the packer element assembly and thus is preferably sloped as well as arcuate to provide a generally truncated conical surface which transitions from having a greater radius proximate to an outer end, or outer face 98 of fin 90 to a smaller radius at an internal diameter 100 which is defined by body 88. Inner shoe 80 also has an inner end, or inner face 99. Inner surface 92 also defines a cylindrical surface on body 88 that engages mandrel 28 in an initial or running position of the tool. Each inner shoe segment 96 has ends 102 and 104 which are flat and convergent with respect to a center reference point which, if the shoe segments are installed about a mandrel will correspond to longitudinal central axis 40 of the mandrel as depicted in FIG. 1. End surfaces 102 and 104 need not be flat and can be of other topology.

Each segment 96 has a fin portion 93 and a body portion 95. Fin portions 93 and body portions 95 comprise body 88 and fin 90, respectively of inner shoe 80. FIG. 4 illustrates inner shoe 80 being made of a total eight inner shoe segments 96 to provide a 360° annulus encircling structure to provide a maximum amount of end support for packer elements to be retained in the axial direction. A lesser amount, or greater amount, of shoe segments can be used depending on the nominal diameters of the mandrel, the packer elements, and the wellbore or casing in which the tool is to be deployed. Inner diameter 100 generally approaches the inner diameter of the packer element assembly. As is apparent from the drawings, outer surface 94 faces outwardly away from the tool. The slope of surface 92 on fin 90 is preferably approximately 45° as shown in FIG. 2. However, the exact slope will be determined by the exterior configuration of the packer element ends that are to be positioned and eventually placed to the contact with retaining shoe 66 and inner surface 92 on fin 90. Inner face 99 of inner shoe 80 is slightly sloped, approximately 5° if desired, but it is also best determined by the surface of the tool which it eventually abuts against when apparatus 10 is centered in the wellbore.

A gap 106 is defined by adjacent ends 104 and 102 of segments 96 before or after downhole tool 10 is set in the well. Gap 106 has a width 109 which can be essentially zero when the segments are initially installed about mandrel 28, and before the tool is moved from the set to the unset position. However, a small gap, for example a gap of .06″ may be provided for on initial installation. The width 109 of gap 106, as will be described in more detail herein below, will increase from that which exists on initial installation as the tool 10 is set.

Referring now to FIG. 6, outer shoe 82 has an inner surface 105 and an outer surface 107. Outer shoe 82 preferably has a plurality of individual shoe segments 108 to form outer shoe 82 which encircles inner shoe 80 and thus encircles mandrel 28. Shoe segments 108 have an inner surface 110, and an outer surface 116. Inner surface 105 of outer shoe 82 defines an inner diameter 112 and thus defines a generally cylindrical surface 114 adapted to engage outer surface of body 88 on inner shoe 80. Inner surface 105 likewise defines a truncated conical surface 115 to accommodate the outer surface of fin 90 and thus transitions from a greater radius proximate external, or outer surface 107 to the inner diameter 112. Ends 118 and 120 of segments 108 are flat and convergent with respect to a center reference point, which if the shoe segments are installed about a mandrel, corresponds to the longitudinal axial centerline such as longitudinal central axis 40 of mandrel 28. End surfaces 118 and 120 need not be flat and can be of other topology.

FIG. 6 illustrates outer shoe 82 being made of a total of eight shoe segments to provide a 360° annulus, or encircling structure to provide the maximum amount of end support. A lesser or greater amount of shoe segments can be used depending upon the nominal diameters of the mandrel, the packer elements in the wellbore or casing in which the tool is to be deployed. A base 121 of outer shoe 82 is slightly sloped, approximately 5°, if desired but is also best determined by the surface of the tool which the shoe will eventually abut against, as for example in this case, the slip wedges 52 and 72. An O-ring 122 is received in a groove 124 in outer shoe 82. Retaining bands 126 are received in grooves 127 to initially hold the segments in place prior to actually setting the tool 10. Gap 128 is a space between adjacent ends 118 and 120 of segments 108 before or after the tool 10 is set. Gap 128 has a width 129 that can be essentially zero when the segments are initially installed about tool 10, but a small gap, such as .06″ may exist after initial installation. The gap will increase in width when the apparatus 10 is set. Retaining bands 126 are preferably made of a non-metallic material, such as composite materials available from General Plastics & Rubber Company, Inc., 5727 Ledbetter, Houston, Tex. 77087-4095. However, shoe retaining bands 126 may be alternatively made of a metallic material such as ANSI 1018 steel or any other material having sufficient strength to support and retain the shoes in position prior to actually setting a tool employing such bands. Furthermore, retaining bands 126 may have either elastic or non-elastic qualities depending on how much radial, and to some extent axial, movement of the shoe segments can be tolerated prior to enduring the deployment of the associated tool into a wellbore. Referring now to FIGS. 1 and 2, apparatus 10 is shown in its unset position 11 and thus the packer element assembly 56 is in its unset position 57. FIG. 3 shows the set position 13 of the tool 10 and the corresponding set position 59 of the packer element assembly 56.

In unset position 57, retaining bands 126 serve to hold segments 108 in place, and thus also hold segments 96 in place. Prior to the tool being set, inner shoe 80 engages mandrel 28 about the upper and lower ends of the packer element assembly 56. Inner shoe 80 of the lower retaining shoe engages lower end 62 of packer element assembly 56 and inner shoe 80 of the upper retaining shoe 68 engages the upper end 60 of packer element assembly 56 in the unset position of tool and the packer element assembly. When the tool has reached the desired location in the wellbore, setting tools as commonly known in the art will move the tool 10 and thus the packer element assembly 56 to their set positions as shown in FIG. 3.

As shown in the perspective view of FIG. 8, inner shoe segments 96 are positioned so that gaps 106 which, as described before, may be zero when initially installed but may also be slightly greater than zero, will be located between the ends 118 and 120 of outer shoe segments 108 Likewise, gaps 128 between ends 118 and 120 of the outer shoe segments 108 will be positioned between the ends 102 and 104 of inner shoe segments 96. Gaps 106 are thus offset angularly from gaps 128. Gaps 128 are thus covered by segments 96, and gaps 106 are covered by segments 108. When the tool is moved to its set position retaining bands 126 will break and retaining shoes 66, namely both of retaining shoes 68 and 70, will move radially outwardly to engage inner surface 24 of casing 22. The radial movement will cause width 109 and width 129 of gaps 106 and 128, respectively, to increase. However, gaps 106 and 128 will still be angularly offset, and thus gaps 128 will remain covered by inner shoe segments 96 of inner shoe 80 while gaps 106 will remain covered by outer shoe segments 108 of outer shoe 82. O-ring 122 will exert a force radially inwardly on outer shoe 82, and will transfer the force to inner shoe 80 as the tool is being moved to its set position 13. The inward force applied by the O-ring 122, along with the friction between inner shoe 80 and outer shoe 82, provides for a generally equal separation between segments 96 and between segments 108, as retaining shoe 66 expands radially outwardly. In other words, the width 109 of each of gaps 106 and the width 129 of gaps 128, will be essentially uniform, or will vary only slightly as the retaining shoe 66 moves radially outwardly to its expanded position.

When the tool is moved to its set position, external, or outer surface 107 of shoe 82 will engage inner surface 24 of casing 22 as will outer end 98 of inner shoe 80. The extrusion of packer elements 58 is essentially eliminated, since any material extruded through gaps 106 will engage segments 108 of outer shoe 82 which will prevent further extrusion. Extrusion is likewise limited by upper and lower slip wedges 52 and 72, respectively. Retaining shoes 66 are thus expandable retaining shoes and will prevent or at least limit the extrusion of the packer elements. Inner and outer retainers 80 and 82 may also be referred to as expandable retainers. The arrangement is particularly useful in high pressure, high temperature wells, since there is no extrusion path available. It should be understood however, that the disclosed retaining shoes may be used in connection with packer-type tools of lesser or greater diameters, differential pressure ratings, and operating temperature ratings than those set forth herein.

Although the inner shoe in the embodiment described herein has a fin and a body, the body portion may be eliminated so that the inner face of the outer shoe will extend so that it engages the outer surface of the mandrel in the unset position. In other words, the inner shoe may comprise only the wing portion so that it will engage the upper and lower ends of the packer element assembly. Such an arrangement is shown in FIG. 10 in cross-section. As shown in FIG. 10, a retaining shoe 150 may be disposed about mandrel 28 and may include a first or inner shoe 152 and a second or outer shoe 154. Inner shoe 152 is generally identical in all aspects to inner shoe 80, except that it does not include a body 88. Outer shoe 154 likewise is similar to outer shoe 82. However, as is apparent from the drawing, outer shoe 154 will engage mandrel 28 in the unset position of the tool. Inner shoe 152 and outer shoe 154, like inner and outer shoes 80 and 82, are comprised of a plurality of segments that will have gaps therebetween when retaining shoe 150 expands radially outwardly to engage a casing in the well. The segments are positioned so that the gaps between segments in inner shoe 152 are covered by the segments that make up outer shoe 154. Likewise, the gaps between segments in outer shoe 154 will be covered by the segments that comprise inner shoe 152. Thus, retaining shoe 150 will prevent, or at least limit, the extrusion of the packer element assembly when it is in the set position.

Components for the packers, frac plugs and bridge plugs described herein may be formed utilizing 3-D printing machines, processes and methods. Various techniques have been developed to use 3-D printers to create prototypes and manufacture products using 3-D design data. See, for example, information available at the Web sites of Z Corporation (www.zcorp.com); Pro Metal, a division of the X1 Company (www.prometal.com); EOS GmbH (www.eos.info); 3-D Systems, Inc. (www.3-Dsystems.com); and Stratasys, Inc. (www.stratasys.com and www.dimensionprinting.com).

The three-dimensional components that make up the tools disclosed herein and other well completion tools may be fabricated directly using a 3-D printer in combination with 3-D design data. Such components may include the mandrel 28, retaining shoes 66, slip wedges 52, slip rings which may be comprised of slip segments 48 and 76, slip ring buttons 49 spacer rings 44. Other components such as pins utilized in the assembly process components may be fabricated directly using a 3-D printer in combination with 3-D design data. 3-D printing is generally a process of making a three-dimensional object from digital design data. 3-D printing is distinct from traditional machining, and is also distinct from traditional methods of fabricating composite components. One method of 3-D printing comprises fabricating three-dimensional objects from computer design models using a material deposition process for example extrusion based layering. Extrusion based layered deposition systems (referred to herein alternatively as fused deposition modeling systems (FDM systems) may be used to build 3-D objects from CAD or other computer design models in a layer-by-layer fashion by extruding flowable materials such as a thermoplastic material. Information regarding such 3-D fabricating processes may be located at the Stratasys Web site.

The materials utilized in the 3-D printing of the packer components should be selected to withstand the downhole environment, without failing, including the ability to withstand high temperatures and pressures and exposures to chemicals. There are a number of thermoplastics that may be utilized to fabricate components for downhole tools using FDM. For example, the following materials may be used to manufacture three-dimensional objects using FDM—polycarbonate (PC), PC-ISO, PC-ABS, ABSplus, ABS-m30, ABS-ES07, ABS; ABS-M30i, polyphenylsulfone and Ultem 9085. Other thermoplastics may be used so long as the resulting component is capable of withstanding temperatures, pressures and chemicals downhole. Components that may be manufactured utilizing 3-D printing processes include but are not limited to extrusion packer shoes, spacer rings, slip ring segments and slip wedges. 3-D printing processes are especially useful for fabricating components with complex geometries, which are otherwise difficult to fabricate. While there are a number of 3-D printing processes that can be utilized to manufacture three-dimensional objects, Ultem 9085, because of its material properties, may be particularly suited for fabrication of downhole tool components using FDM.

Downhole tools according to the current disclosure may therefore include a downhole tool for use in a well comprising a mandrel, a sealing element disposed about the mandrel for engaging the well in a set position of the tool, a retaining shoe at one of the first and second ends of the sealing, and a slip wedge disposed about the mandrel abutting the retaining shoe characterized in that at least one of the retaining shoe and slip wedge is formed by a 3-D printing process. The downhole tool may further comprise first and second retaining shoes at the first and second ends of the sealing element, first and second slip wedges disposed about the mandrel abutting the first and second shoes respectively; first and second slip rings for engaging the well in the set position of the tool; and first and second support rings for axially retaining the first and second slip rings characterized in that at least one of the first and second support rings, first and second slip rings, first and second slip wedges and first and second retaining shoes are formed by a 3-D printing process. The 3-D printed components of the downhole tool may be made using a material deposition process, and may be comprised of a thermoplastic material, for example, ULTEM 9850. The 3-D printed components of the downhole tool may comprise at least one of the first and second support rings, slip rings, slip wedges and shoes formed from a thermoplastic material, and may also comprise the mandrel, mule shoe and other components.

Although the disclosed invention has been shown and described in detail with respect to a preferred embodiment, it will be understood by those skilled in the art that various changes in the form and detailed area may be made without departing from the spirit and scope of this invention as claims. Thus, the present invention is well adapted to carry out the object and advantages mentioned as well as those which are inherent therein. While numerous changes may be made by those skilled in the art, such changes are encompassed within the spirit of this invention as defined by the appended claims.

What is claimed is:

1. A downhole tool for use in a well comprising:
a mandrel;
a sealing element disposed about the mandrel for engaging the well in a set position of the tool;
a retaining shoe at one of the first and second ends of the sealing element; and
a slip wedge disposed about the mandrel abutting the retaining shoe characterized in that at least one of the retaining shoe and slip wedge is formed by a 3-D printing process.

2. The downhole tool of claim 1 comprising:
first and second retaining shoes at the first and second ends of the sealing element;
first and second slip wedges disposed about the mandrel abutting the first and second shoes respectively;
first and second slip rings for engaging the well in the set position of the tool; and
first and second support rings for axially retaining the first and second slip rings;
characterized in that at least one of the first and second support rings, first and second slip rings, first and second slip wedges and first and second retaining shoes are formed by a 3-D printing process.

3. The tool of claim 2, characterized in that the at least one of the first and second support rings, slip rings, slip wedges and shoes is formed from a thermoplastic material.

4. The tool of claim 2, characterized in that at the at least one of the first and second support rings, slip rings, slip wedges and shoes is formed using a material deposition process.

5. The apparatus of claim 2, characterized in that the first and second spacer rings are formed using a material deposition process.

6. The apparatus of claim 2, characterized in that the first and second retaining shoes are formed by using a material deposition process.

7. The tool of claim 6, wherein each of the first and second shoes comprise a plurality of first and second shoe segments, the first shoe segments comprising:
a body portion, wherein the body portion engages the packer mandrel when the shoe is in an unset position; and
a fin portion extending radially outwardly from the body portion for engaging an end of the sealing element.

8. The downhole tool of claim 1, characterized in that the mandrel is formed by a 3-D printing process.

9. A retaining shoe for limiting the extrusion of a packer element assembly disposed about a packer mandrel, wherein the packer element assembly is movable from an unset to a set position in a wellbore and the packer assembly seals against the wellbore in the set position comprising:
a plurality of first shoe segments encircling the packer mandrel, adjacent ones of the first shoe segments having gaps therebetween; and
a plurality of second shoe segments disposed about the first shoe segments, adjacent ones of the second shoes having gaps therebetween, wherein the second shoe segments overlap the gaps between the first shoe segments, characterized in that at least a portion of the first and second shoe segments are manufactured using a 3-D printing process.

10. The apparatus of claim 9, wherein the at least a portion of the first and second shoe segments fabricated using the 3-D printing process are formed from ULTEM 9085.

11. The retaining shoe of claim 9, wherein the first shoe segments define a sloped, arcuate inner surface for engaging an end of the packer element assembly and wherein the second shoe segments define a sloped, arcuate inner surface for engaging a sloped arcuate outer surface of the first shoe segments.

12. The retaining shoe of claim 9 characterized in that each of the first and second shoe segments are formed by a 3-D printing process.

13. The retaining shoe of claim 12, the 3-D printing process comprising a material deposition process.

14. The retaining shoe of claim 13, wherein the shoes are formed from a thermoplastic material having a tensile strength of at least 10,000 psi.

15. A downhole tool comprising:
a mandrel;
a packer element disposed about the mandrel; and
a shoe at the lower end of the packer element at least one slip ring positioned on the mandrel for engaging the well characterized in that at least one of the shoe and slip ring is comprised of a thermoplastic material and fabricated using a 3-D printing process.

16. The downhole tool of claim 15 further comprising:
upper and lower shoes at the upper and lower ends of the packer element;
upper and lower slip ring assemblies positioned on the mandrel for engaging a well; and
upper and lower spacer rings for axially retaining the upper and lower slip ring assemblies, characterized in that at least one of the shoes, slip ring assemblies, and spacer rings are comprised of a thermoplastic material and fabricated using a 3-D printing process.

17. The downhole tool of claim 16, wherein the at least one of the shoes, slip ring assemblies, and spacer rings is formed using a material deposition process.

18. The downhole tool of claim 16, wherein the spacer rings are comprised from ULTEM 9085.

19. The downhole tool of claim 15, characterized in that the mandrel is comprised of a thermoplastic material.

20. The downhole tool of claim 19, characterized in that the mandrel is fabricated using a 3-D printing process.
